(19) United States
(12) Patent Application Publication
(10) Pub. No.: US 2024/0293794 A1
(43) Pub. Date: Sep. 5, 2024

(54) Method for removing petroleum and other liquid hydrocarbons from a body of water, using a floating absorbent, a method of absorbent manufacturing, a method of hydrocarbon recovery and absorbent regeneration

(71) Applicants: Robert Bado, Delray Beach, FL (US); Artem Madatov, North Bethesda, MD (US)

(72) Inventors: Robert Bado, Delray Beach, FL (US); Artem Madatov, North Bethesda, MD (US)

(21) Appl. No.: 18/116,142

(22) Filed: Mar. 1, 2023

(51) Int. Cl. B01J 20/20; B01J 20/26; B01J 20/28; B01J 20/30; B01J 20/34; C02F 1/28; C10G 25/11; C10G 25/12; E02B 15/04

(52) U.S. Cl. CPC B01J 20/20; B01J 20/261; B01J 20/2803; B01J 20/28095; B01J 20/3028; B01J 20/3042; B01J 20/3064; B01J 20/3416; B01J 20/3425; B01J 20/3466; C02F 1/283; C02F 1/285; C10G 25/11; C10G 25/12; E02B 15/041; C02F 2101/32; C02F 2303/16

(57) ABSTRACT

The present invention provides a method for removing petroleum and other liquid hydrocarbons from a body of water, using an environmentally friendly and inexpensive bi-component granular compound with sorption and buoyant properties, wherein one of the components of the compound is a microporous absorbent material that due to its high sorption capacity, is effective in removing petroleum and other liquid hydrocarbons from the surface of a body of water, and another component is a macroporous buoyant material with closed cell structure, the subsequent extraction of the absorbent compound impregnated with petroleum and other liquid hydrocarbons from the body of water, with further hydrocarbon recovery by distillation, and microporous component re-activation, that are carried out inside a fluidized bed reactor, using superheated steam, a method of bi-component granular floating absorbent compound manufacturing.

### FIELD OF THE INVENTION

The invention relates to technologies for cleaning bodies of water from pollutants, in particular from spills of petroleum and petroleum products e.g. gasoline, diesel fuel, kerosene, oils, fuel oil, which form thin films on the water surface that are difficult to remove.

### BACKGROUND OF THE INVENTION

Spills of petroleum and petroleum products on bodies of surface water are a common event and a widespread problem. Such man-made disasters cause irreparable damage to the environment, leading to the pollution of water bodies, the death of flora and fauna in the polluted area. In addition, it is also necessary to take into account the financial damage, since colossal quantities of expensive hydrocarbons are lost due to the absence of an effective cleaning, collection and recovery methods. Practically all methods of cleaning the surface of bodies of water from petroleum products, as well as special absorbents used in those methods, have a rather low sorption efficiency and a number of other significant disadvantages. Taking into consideration that during accidents of oil tankers, ruptures of underwater pipelines, leaks from sea wells, the quantity of spilled petroleum reaches hundreds of thousands of tons, it is necessary to use large quantities of cheap and effective absorbent. Therefore, development of new methods of collecting hard-to-remove oil films from the surface of polluted water by using new absorbents, as well as simple and economically profitable methods of producing such absorbents are of utmost importance.

A known method of collecting oil films from the surface of water is by towing loop-shaped chain of floating booms (ropes) over the surface of water behind the vessel. In this case, oil products are collected in the narrowest part of the loop in the form of a more or less thick layer and can be skimmed into special containers for further disposal. However, only a part of oil products can be collected. Incomplete removal of oil products from a body of water threatens the death of aquatic organisms, significant pollution of the shore eco-system.

Another known method of removing oil products from the surface of bodies of water, using booms, made of nets filled with fibrous oil absorbent materials, as hydrophobized viscose, polypropylene, polyethylene, polyethylene terephthalate, polyurethane, etc. Due to absorbent materials' properties, oil products are spread on the surface of those absorbent materials as a thin layer of 1-20 microns, thus, are removed from the water surface more efficiently than by solid booms. However, the specific surface area of the fibrous material is less than a square meter per gram. Therefore, the absorption capacity of such materials is low, about 0.1%-2% by weight of the fibrous material. Because of this the efficiency is insufficient.

High cost of polymeric materials used in booms, the cost of removing petroleum products absorbed by the booms are prohibitively high to justify their widespread use. Another disadvantage of this cleaning method, if the volume of spilled petroleum products on the water surface is significant and the layer thickness of such products attached to the boom material is above 20 microns, the petroleum products begin to separate from the absorbent material and spread over the surface of water.

A known method of water purification from petroleum products is by passing polluted water through activated carbon is devoid of these disadvantages. Activated carbon has micropores with a size of 0.01-1 micron, occupying 50-60% of the total volume of carbon granule. Thus, the surface area of activated carbon micropores is up to 1200 square meters per 1 gram of activated carbon. The quantity of petroleum products absorbed by activated carbon is 50-60% of the carbon weight. This increases the efficiency of water treatment compared to fibrous materials, and drastically reduces its cost. However, the density of activated carbon saturated with oil products turns out to be greater than the density of water and such impregnated by petroleum products activated carbon sinks in water. When the pieces of activated carbon placed onto water surface for cleaning, they end up at the bottom of the body of water along with absorbed oil products, thus cannot be collected from the surface.

A known method of water purification from oil products by using porous floating absorbents based on foamed polymeric materials, mainly polyurethane, having both open pores for sorption and closed pores for buoyancy. However, since the foamed materials have mainly macropores rather than micropores, their specific surface area is up to 1-2 square meters per 1 gram of the absorbent. The sorption capacity of such absorbents is no more than 1-2% of petroleum products by weight of the absorbent, and the cost of such materials is quite high.

### SUMMARY OF THE PRESENT INVENTION

The present invention provides a method for removing petroleum and other liquid hydrocarbons from a body of water, using an environmentally friendly and inexpensive bi-component granular compound with sorption and buoyant properties, wherein one of the components of the compound is a microporous absorbent material that due to its high sorption capacity, is effective in removing petroleum and other liquid hydrocarbons from the surface of a body of water, and another component is a macroporous buoyant material with closed cell structure.

The microporous material with open pores is activated carbon. The use of activated carbon is warranted by its high sorption efficiency, in particular, the surface area of micropores is up to 1200 square meters per 1 gram of activated carbon. The quantity of petroleum products absorbed by activated carbon reaches 50-60% of the weight of carbon, ensuring high efficiency of water purification and remarkable economic feasibility.

The macroporous buoyant material is a closed cell foamed polymer, for example, polystyrene, polyethylene, polypropylene. The foamed polystyrene is an inexpensive and commonly used material, allowing to reduce the production cost of the claimed absorption compound.

It is preferable to use the compound in which about 10-30 granules of the microporous component with open pores attached to the surface of one granule of the macroporous component with closed cells. This ratio of microporous and macroporous component granules enables efficient sorption of petroleum and other hydrocarbons from the water surface, and ensures the absorbent compound granules with absorbed petroleum remain on the surface of a body of water and can be easily collected by simple means.

Another aspect of the claimed invention is a method of obtaining the buoyant sorption compound with the required properties. This is accomplished by bonding the granules of the components together, wherein a granule of the macroporous component 3-10 mm in size is surrounded on all sides by 10-30 granules of the microporous component 1-5 mm in size.

Another aspect of the claimed invention is a method for cleaning the surface of water from petroleum products, ensuring highly effective removal of petroleum products from the surface of a body of water, as well as environmental safety and high economic efficiency. This is achieved by placing the floating absorbent compound onto a surface of the body of water contaminated with petroleum and other liquid hydrocarbons in quantities slightly exceeding the calculated need for a given volume of spilled petroleum. The floating absorbent spreads over the water surface and comes into contact with the spilled hydrocarbons. The absorbent starts working immediately upon application with a high rate of absorption. Petroleum impregnates the micropores of the sorption component of the compound and remains inside the granules for an indefinitely long time. The compound absorbs 10 times its weight in petroleum.

Upon completion of the sorption phase, the floating on the water surface impregnated by petroleum absorbent compound is collected from the water surface to undergo petroleum product recovery by distillation, pyrolysis and regeneration within a reactor-activator. The regenerated absorbent is used again for producing the bi-component floating absorbent compound and further petroleum spill cleanup.

The claimed method provides for highly efficient removal of petroleum products from the surface of water bodies, ensures environmental safety and high economic efficiency. The economic efficiency of the proposed method is ensured both by the possibility of reusing the absorbent material and by the possibility of further use of the recovered petroleum products.

### BRIEF DESCRIPTION OF THE DRAWINGS

FIG. 1 is a schematic drawing of the buoyant absorbent compound granule.

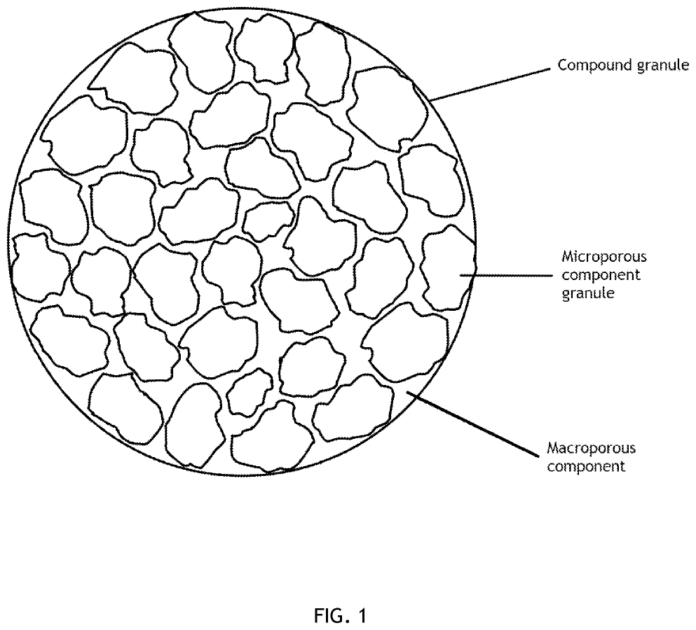

FIG. 2 is a schematic drawing of the method of processing the used bi-component absorbent compound inside a reactor-activator, using petroleum distillation process, pyrolysis of heavy hydrocarbons and activation of the obtained pyrocarbon.

### DETAILED DESCRIPTION OF THE INVENTION

The present invention provides a method for removing petroleum and other liquid hydrocarbons from a body of water, using an environmentally friendly and inexpensive bi-component granular compound with sorption and buoyant properties, wherein one of the components of the compound is a microporous absorbent material that due to its high sorption capacity, is effective in removing petroleum and other liquid hydrocarbons from the surface of a body of water, and another component is a macroporous buoyant material with closed cell structure.

A method for manufacturing a floating absorbent consists of two main phases. The first phase is activation of pyrolytic carbon obtained by pyrolysis of carbonaceous materials with water vapor at a high temperature of 700-1000° C., wherein the water vapor burns out 50-60% of the mass of carbon, creating a large number of micropores within it. During this process, the water gas, a mixture of carbon monoxide and hydrogen, is produced, and is used to provide the activation process with required heat. The resulting activated carbon is then cooled, crushed and dispersed on sieves to obtain the target fraction, 1-5 mm large granules.

To increase the sorption capacity and increase the speed of petroleum absorption, the microporous component, activated carbon, is treated with vapors of a hydrophobizing agent, for example, by vapors of polyolefins, such as polytetrafluoroethylene, polyethylene, polypropylene at a temperature of 250-350° C. After such treatment, the surface of micropores becomes hydrophobic and oleophilic. Therefore, the penetration rate of light hydrocarbons with low viscosity increases and they quickly fill up the micropores. The absorbent can hold an amount of oil up to ten times its own weight.

The second phase of the floating absorbent manufacturing involves mixing the activated carbon granules with a granular self-foaming polymer material, for example, polystyrene, polyethylene, polypropylene with addition of pentane or ammonium carbonate in the ratio of 1 granule of polymer material per 10-30 granules of activated carbon, followed by heating the resulting polymer-activated carbon mixture to a foaming temperature of the polymer material (100-150° C.) in a special apparatus, a steam chamber. At this temperature, the polymer softens and acquires sticky properties, while simultaneously increasing in volume by 10-20 times due to foaming and the formation of macropores. As a result, the activated carbon granules bond to the expanded polymer granules. Prior to mixing the components, the polymer granules are covered with a layer of hot-melt adhesive, a substance that softens at a temperature lower than the foaming temperature of the polymer granules, for example, polyvinyl alcohol. In this case, the adhesion of activated carbon granules to polymer granules increases significantly. After the resulting bi-component compound granules are cooled to a room temperature, the compound granules are sifted through a sieve with a mesh size of 5-6 mm to separate non-bonded activated carbon granules from the finished bi-component absorbent compound, to mix anew the lose activated carbon granules with the self-foaming polymer material.

Body of water clean-up process from petroleum and other liquid hydrocarbons, using a floating absorbent is conducted by dispersing the bi-component absorbent compound over a contaminated surface of a body of water from a vessel or an aircraft in a quantity slightly exceeding the calculated need for a given amount of spilled petroleum. The floating absorbent compound, under the forces of nature, i.e. wind, waves, currents, spreads over the surface of water and gets in contact with the petroleum film. Petroleum and any other liquid hydrocarbons enter the micropores of the microporous component of the compound granules, envelope them and remain inside the microporous granules for an indefinitely long time. Upon absorption of hydrocarbons from the surface of water, the impregnated by petroleum products absorbent is collected for processing. The microporous component of the compound gets regenerated, the absorbed petroleum products are extracted from the activated carbon granules. The regenerated absorbent is again used to absorb petroleum products. The absence of waste in form of used absorbent ensures the ecological safety of the proposed method for cleaning water bodies.

Regeneration of the used microporous absorbent component of the bi-component compound is carried out in three sequential processes inside a pyrolysis reactor-activator 1,

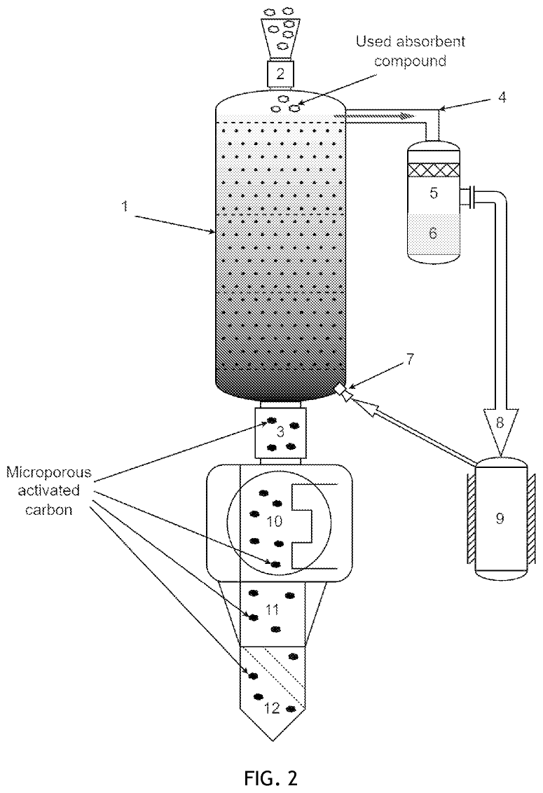

FIG. 2, namely petroleum distillation, pyrolysis of heavy hydrocarbons and activation of the obtained pyrocarbon. The reactor is a vertical hermetically sealed, heat-insulated column with two sluices on its opposite ends, wherein the upper sluice 2 is intended for loading the used petroleum-soaked absorbent compound granules and the lower sluice 3 is used for discharging activated carbon. In the upper part of the reactor, there is a gas outlet pipe 4 for delivering a mixture of pyrolysis and water gases, as well as petroleum vapors into a cooler-condenser 5 for cooling and condensation of petroleum 6. In the lower part of the reactor, there are nozzles 7 for supplying superheated steam to activate the pyrocarbon in the fluidized bed.

The process of microporous component regeneration goes through three stages within three active zones inside the pyrolysis reactor-activator. The used petroleum-soaked absorbent compound is loaded into pyrolysis reactor-activator through the upper sluice, then moves from the top to bottom under the force of gravity. The reactivated microporous component, activated carbon, is discharged from the bottom sluice. During the process, the used compound is gradually heated in the upper zone of the pyrolysis column from the ambient temperature to 400° C. by a counter-current of hot gases and steam coming from lower zones of the column. It makes liquid hydrocarbons boil and evaporate from the microporous component's pores. Hydrocarbon vapors, together with gases, leave the reactor through the gas outlet pipe to the cooler-condenser 5, where the liquid hydrocarbons 6 condense and separate from the gas 8. The gas is then sent for combustion to the steam generator 9 to produce superheated steam. The used bi-component compound processed in the upper zone continues descending to the middle zone of the pyrolysis column, where it is heated to 500-600° C. Heavy hydrocarbons and the macroporous polymeric component of the absorbent compound undergo pyrolysis, producing gas, a mixture of methane, ethane, ethylene, propylene, and hydrogen, and pyrocarbon. Carbon component of the absorbent compound undergoes no changes during this stage. The resulting material, pyrocarbon, descends to the lower zone of the reactor, where it is heated by the superheated steam coming from below through the nozzles to a temperature of 700-1000° C. Part of the carbon is getting burned out, forming the micropores of the activated carbon. During this interaction of carbon and water, the water gas is formed, which mixes with the processed material, forming a fluidized bed, and ascends to the overlying zones of the reactor, heating the material coming from above. The produced activated carbon is discharged from the reactor through the lower sluice into the cooler 10, then crushed in the crusher 11 and dispersed on sieves 12 to obtain the target 1-5 mm large granules of microporous activated carbon. After hydrophobization it gets mixed with the macroporous polymer component to create new quantities of absorbent compound.

Thus, carrying out a complete cycle consisting of three processes in one apparatus creates a new qualitative feature: the heat carrier for each process is steam-gas by-products of the subsequent process, which saves thermal energy and provides energy for the finished product due to the combustion of by-products of chemical reactions. The novelty of the proposed method lies in the possibility of reusing the extracted hydrocarbons.

1. A method for removing petroleum and other liquid hydrocarbons from a body of water by placing granules of a bi-component floating porous absorbent compound on a surface of a body of water, characterized in that the collected from the body of water absorbent compound, impregnated with liquid hydrocarbons, undergoes hydrocarbon recovery by distillation, and absorbent re-activation.

2. A floating component of the bi-component compound according to claim 1, characterized in that the component is a foamed closed cell macroporous polymer, preferably polystyrene, polypropylene, polyethylene or any other similar foamed polymer material.

3. A absorbent component of the bi-component compound according to claim 1, characterized in that the component is an open pore microporous activated carbon.

4. A method according to claim 3, characterized in that the absorbent component is hydrophobized by treatment with polyolefin vapors.

5. The bi-component compound according to claim 1, characterized in that the components are bonded to each other, so that one granule of the macroporous component is surrounded on all sides by a plurality of granules of the microporous component.

6. A method according to claim 5, characterized in that the components are bonded to each other by heating the mixture of granules of the both components to the foaming temperature of the macroporous polymer component.

7. A method according to claim 6, characterized in that prior to mixing the components, the polymer component granules are covered with a layer of hot-melt adhesive, the softening temperature of which is lower than the foaming temperature of the polymer component.

8. A method according to claim 1, characterized in that the hydrocarbon distillation, pyrolysis and microporous component re-activation processes are carried out inside a fluidized bed reactor, using superheated steam.
